(19) United States
(12) Patent Application Publication
(10) Pub. No.: US 2012/0050646 A1
(43) Pub. Date: Mar. 1, 2012

(54) Scattering Tunable Display Using Reflective and Transmissive Modes of Illumination

(76) Inventors: Jiandong Huang, Vancouver, WA (US); Apostolos T. Voutsas, Portland, OR (US)

(21) Appl. No.: 12/877,017

(22) Filed: Sep. 7, 2010

Related U.S. Application Data
(63) Continuation-in-part of application No. 12/873,188, filed on Aug. 31, 2010.

(51) Int. Cl. G02F 1/1335

(52) U.S. Cl. 349/65; 349/114

(57) ABSTRACT

A scattering tunable display is provided that uses reflection and edge-lit waveguide transmission modes of illumination. A front panel is provided with an array of selectable display pixels arranged in a plurality of sequences. A backlight panel includes a plurality of edge-coupled waveguide pipes formed in a plurality of rows. Each waveguide pipe has an optical input connected to a corresponding light emitting diode (LED), and an optical output index-matched to a corresponding sequence of display pixels. A display pixel is enabled and ambient visible spectrum illumination is measured. In response to the measured ambient illumination being above a first minimum threshold, the display pixel is operated in a reflective illumination mode. In response to the measured ambient illumination being below the first minimum threshold, the display pixel is operated in a transmissive illumination mode.

### RELATED APPLICATION

The application is a Continuation-in-Part of a pending application entitled, THREE-DIMENSIONAL DISPLAY USING ANGULAR PROJECTION BACKLIGHT, invented by Huang et al., Ser. No. 12/873,188, filed on Aug. 31, 2010, Attorney Docket No. SLA2739.

### BACKGROUND OF THE INVENTION

1. Field of the Invention

This invention generally relates to electronic displays and, more particularly, to a display capable of operation using both ambient and internally generated illumination sources.

2. Description of the Related Art

As the thickness of flat-panel liquid crystal (LC) displays is reduced to below 1 centimeter (cm), conventional backlight designs such as compact fluorescent lamp (CFL), which require that the light sources be distributed across the backlight panels, cannot be used due to the geometry limitations of these light sources. Ultra-thin display designs might be implemented using LEDs with small-volume packages. But the cost of these implementations can be high since a large number of LEDs would be required.

Display designs with edge-coupled LEDs using large-size multiple-mode waveguide light pipes enable ultra-thin LC display designs while reducing the number of LEDs used in those displays as well. The edge-coupled schemes reduce the cost of backlight dramatically in addition to supporting the stylish thin look of the displays.

However, the image quality of these edge-coupled displays cannot match that of displays using distributed LEDs as backlight light sources in the backlight panels. For the latter case, each LED light extraction cell of the backlight systems can be individually addressed to create low resolution images of desired images. With the synchronization of backlight low resolution images, in time and spatial domain, to the images on the front high-resolution LC panels, high quality images can be realized with higher contrasts and dynamic responses. In this kind of display implementation, the capability to address desired backlight light extraction cells is the key enabling technology, which is not easily achievable using edge-coupled LED backlight systems.

Regardless of whether an LED or CFL light source is used, LCD panel displays require a significant amount of power to operate, which is a disadvantage if the display is a portable battery-operated unit. Reflective display technology is attractive because these displays consume substantially less power than LCDs displays, by eliminating the power consumption of the backlight source. Some examples of reflective display technologies include electrophoretic, electrowetting, electrochromic, and interference-based MEMS displays. However, the operation of these types of displays completely depends on the availability of ambient light, dramatically limiting their application as a consumer product capable of operating in all kinds of environments, including dark or very dim ambient light conditions.

It would be advantageous if a reflective display could be operated with a backlight when ambient light conditions are dim.

### SUMMARY OF THE INVENTION

Disclosed herein is a display that can be operated in both reflection and transmission modes to meet everyday operational demands, while keeping power consumption low. The display is based upon a pixel micro-scattering mechanism. This mechanism permits the consistent operation of display pixels in both the reflection and transmission modes. The consistency of operational modes enables uniform display controls under either operational mode, dramatically reducing design and algorithm development.

Accordingly, a scattering tunable display method is provided that uses reflection and edge-lit waveguide transmission modes of illumination. A front panel is provided with an array of selectable display pixels arranged in a plurality of sequences. A backlight panel includes a plurality of edge-coupled waveguide pipes formed in a plurality of rows. Each waveguide pipe has an optical input connected to a corresponding light emitting diode (LED), and an optical output index-matched to a corresponding sequence of display pixels. A high absorption layer underlies the backlight panel. The method selects a display pixel to enable, and measures ambient visible spectrum illumination incident to a top surface of the front panel. In response to the measured ambient illumination being above a first minimum threshold, the display pixel is operated in a reflective illumination mode. In response to the measured ambient illumination being below the first minimum threshold, the display pixel is operated in a transmissive illumination mode.

If the measured ambient illumination is below the first minimum threshold, but above a second minimum threshold, the display pixel is operated in a combination of both reflective and transmissive illumination modes. If the measured ambient light is above the first minimum threshold, the selected display pixel is operated exclusively in the reflective mode. If the measuring ambient illumination is below the second minimum threshold, the display pixel is operated primarily in the transmissive illumination mode.

The front panel selectable display pixels include a medium of liquid crystal molecules, embedded in a polymer network, and interposed between transparent electrodes, and the display pixels are operated by creating a biased potential between the electrodes of a selected display pixel. By supplying an ON voltage, the medium in the selected display pixel operates at a high scattering strength, returning incident light with a maximum reflection efficiency. By enabling an LED corresponding to a waveguide pipe underlying the selected display pixel and supplying the ON voltage, the medium in the selected display pixel operates at the high scattering strength, and extracts light received from the waveguide pipe with a maximum extraction efficiency.

Additional details of the above-described method and a scattering tunable display using reflection and edge-lit waveguide transmission modes of illumination are presented below.

### BRIEF DESCRIPTION OF THE DRAWINGS

FIGS. 1A, 1B, and 1C are respectively, a partial cross-sectional view and two plan views of a scattering tunable display using reflection and edge-lit waveguide transmission modes of illumination.

FIG. 2 is a partial cross-sectional view contrasting the operation of enabled and non-enabled display pixels

FIG. 3 is a partial cross-sectional view depicting a display operating in both reflective and transmissive modes of operation.

FIG. 4 is a partial cross-sectional view depicting a display operating in only the reflective mode of operation.

FIG. 5 is a partial cross-sectional view depicting a display operating in primarily the transmissive mode of operation.

FIG. 6 is a schematic diagram depicting an exemplary front panel.

FIGS. 7A, 7B, and 7C are, respectively, a partial cross-sectional view, detailed partial cross-sectional view, and plan view illustrating the concept of addressing individual backlight display pixels for an edge-coupled LED backlight system.

FIG. 8 is a graph depicting a scattering function (radar cross section) as a function of particle size.

FIG. 9 is a flowchart illustrating a scattering tunable display method using reflection and edge-lit waveguide transmission modes of illumination.

### DETAILED DESCRIPTION

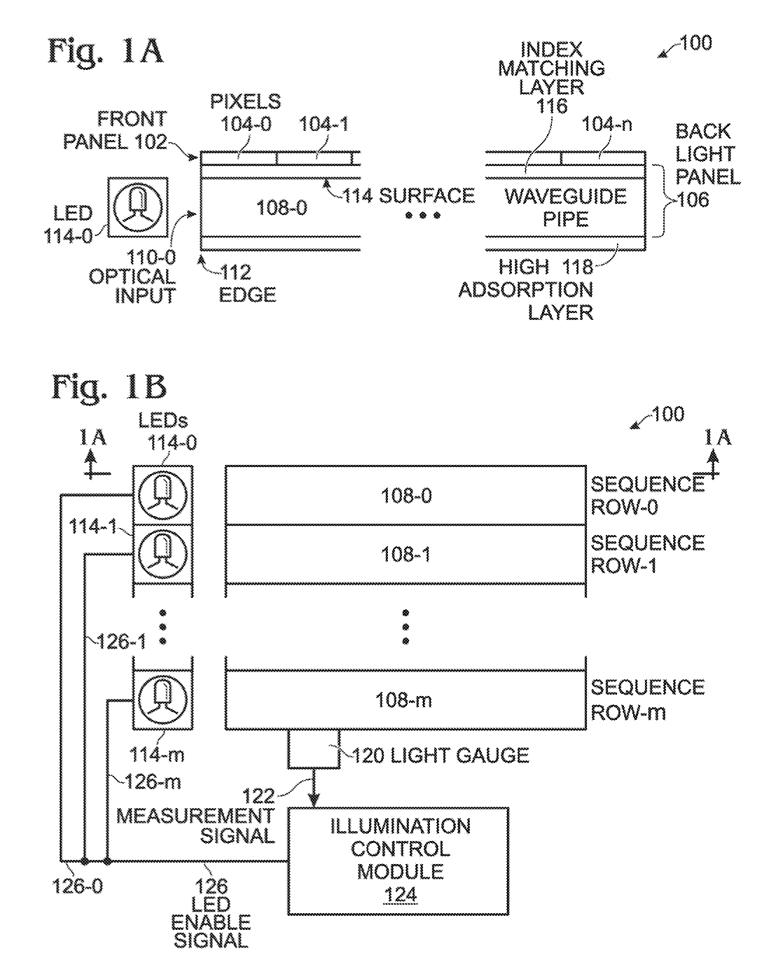

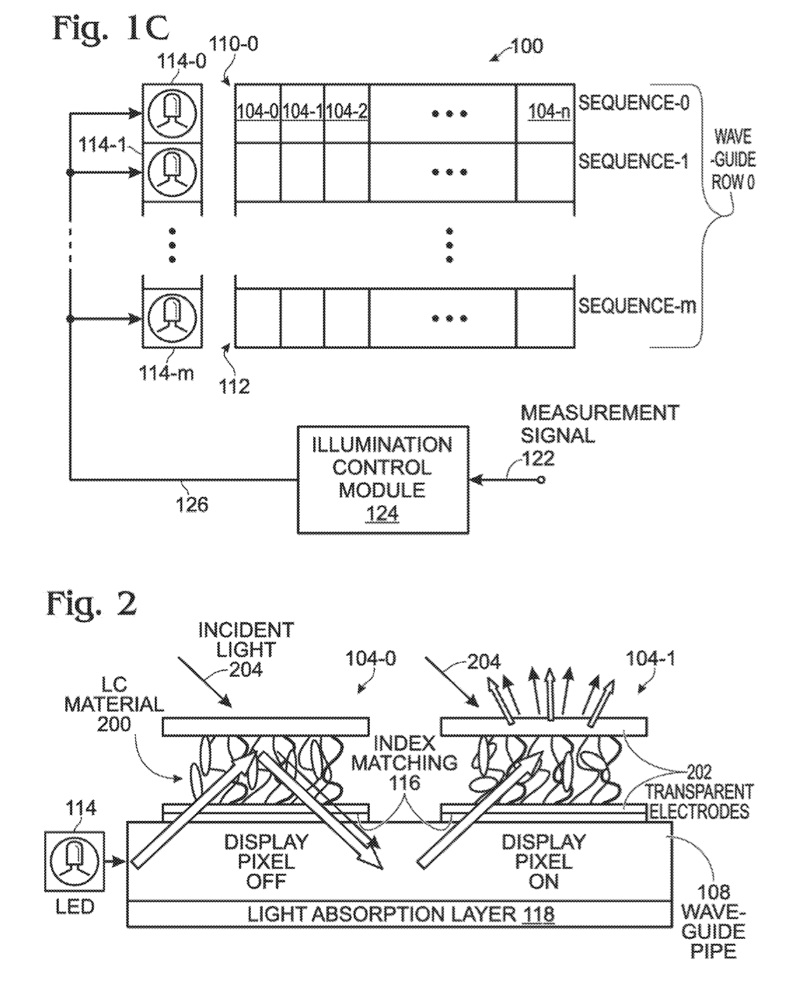

FIGS. 1A, 1B, and 1C are respectively, a partial cross-sectional view and two plan views of a scattering tunable display using reflection and edge-lit waveguide transmission modes of illumination. The display 100 comprises a front panel 102 with an array of selectable display pixels 104 arranged in a plurality of sequences. Shown are pixels 104-0 through 104-n in each sequence. Also shown are sequences 0 through m, where n and m are integer variables not limited to any particular value. A backlight panel 106 includes a plurality of edge-coupled waveguide pipes 108 formed in a plurality of rows. Shown are rows 0 through m (waveguide pipes 108-0 through 108-m), with each waveguide pipe row being associated with a display pixel sequence. In other aspects not shown, a waveguide row may be associated with a plurality of adjacent sequences. Each waveguide pipe 108 has an optical input 110 connected to an edge 112 and an optical output surface 114 underlying a corresponding display pixel sequence. Note: the front panel and index matching layer are not shown in FIG. 1B, so that the waveguide pipes can be viewed.

A plurality of light emitting diodes (LEDs) 114-0 through 114-m are shown. Each LED 114 has an optical output connected to a corresponding waveguide pipe edge 112. In one aspect not shown, more than one LED may be interfaced to the waveguide pipe edge. In other aspects not shown, an LED may be interfaced to both edges (ends) of every waveguide pipe. An index-matching layer 116 is interposed between the backlight panel 106 and the front panel 102. A high absorption layer 118 underlies the backlight panel 106. This layer (118) has low reflectivity through the whole visible spectrum, turning the incidental light into heat. Ideally, layer 118 is a black-body in physics.

A light gauge 120 is mounted to the front panel 102, and has an electrical output on line 122 to supply a measurement signal responsive to the intensity of ambient visible spectrum light incident to the front panel. An illumination control module 124 has an input on line 122 to accept the measurement signal and an output on line 126 to supply an LED enable signal responsive to the measurement signal. In response to an ambient illumination measurement above a first minimum threshold, the illumination control module 124 operates selected display pixels in a reflective illumination mode. In response to the ambient illumination measurement being below the first minimum threshold, the illumination control module 124 operates the selected display pixels in a transmissive illumination mode.

In one aspect as shown in FIG. 1C, the display may be comprised of a single waveguide pipe (e.g., row 0). The backlight panel has a single edge-coupled waveguide pipe (e.g., row 0) with an optical input connected to an edge and an optical output surface underlying the plurality of display pixel sequences (sequences 0 through m). A plurality of LEDs 114 are used, with each LED having an optical output connected to the waveguide pipe edge.

FIG. 2 is a partial cross-sectional view contrasting the operation of enabled and non-enabled display pixels. Each display pixel includes a medium 200 of liquid crystal molecules, embedded in a polymer network, and interposed between transparent electrodes 202. In some aspects, the bottom electrode 202 is an index matching material 116. The medium 200 in a selected display pixel 104-1 operates with a high scattering strength in response to an ON voltage between the electrodes 202, returning incident light 204 (black arrow) with a first reflection efficiency. The medium 200 in non-selected display pixel 104-0 operates with a low scattering strength in responsive to an OFF voltage between the electrodes, returning incident light 204 with a second reflection efficiency, less than the first reflection efficiency. Note: most of the incident light 204 passes through display pixel 104-0 to the light absorption layer 118.

If the illumination control module enables an LED 114 corresponding to a waveguide pipe 108 underlying the selected display pixel 104-1, as shown, the medium 200 in the selected display pixel operates with a high scattering strength in responsive to an ON voltage between the electrodes 202, extracting light (whitearrow) from the waveguide pipe 108 with a first extraction efficiency. The medium 200 in non-selected display pixel 104-0 operates with a low scattering strength in responsive to an OFF voltage between the electrodes 202, extracting light from the waveguide pipe 108 with a second extraction efficiency, less than the first extraction efficiency. Note: most of the light transmitted to pixel 104-0 from the waveguide pipe is reflected back to the light absorption layer 118.

The response of polymer network liquid crystal molecules to an electric field is the major characteristic utilized in industrial applications. The ability of the director to align along an external field is caused by the electric nature of the molecules. Permanent electric dipoles result when one end of a molecule has a net positive charge while the other end has a net negative charge. When an external electric field is applied to the liquid crystal, the dipole molecules tend to orient themselves along the direction of the field. Even if a molecule does not form a permanent dipole, it can still be influenced by an electric field. In some cases, the field produces a slight re-arrangement of electrons and protons in molecules such that an induced electric dipole results. While not as strong as permanent dipoles, an orientation with the external field still occurs.

Because of the birefringence of liquid crystal materials, the effective refractive index may be a squared average of the indexes along two directions. Therefore, depending on the LC molecule alignment, different effective indexes can be achieved. If all the LC molecules are aligned in parallel to an incident light ray, the effective index reaches its minimum value nₒ, i.e., the ordinary refractive index value. If the LC molecules are aligned perpendicular, the effective index reaches the maximum value square root of ((n_{c}²+nₒ²)/2). This refractive index change is the largest value that can be achieved with a nematic liquid crystal. In summary, and as explained in more detail below, the scattering characteristics in an LC cell change in response to the local orientation of the LC dipoles in polymer networks.

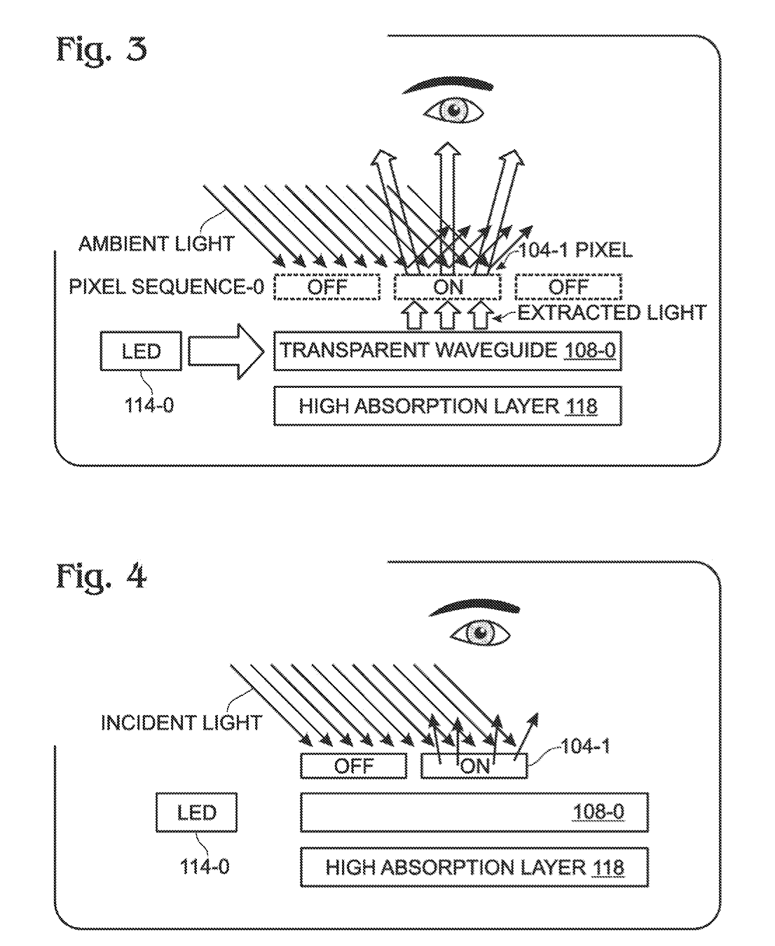

FIG. 3 is a partial cross-sectional view depicting a display operating in both reflective and transmissive modes of operation. If the illumination control module 124 (see FIG. 1B) receives a measurement signal below the first minimum threshold, but above a second minimum threshold, it supplies an LED enable signal (e.g., on line 126-0) to an LED (e.g., LED 114-0) corresponding to a waveguide pipe 108-0 underlying a selected display pixel (e.g., display pixel 104-1 in sequence 0). The selected display pixel 104-1 returns both ambient incident light and transmits light extracted from the underlying waveguide pipe 108-0.

FIG. 4 is a partial cross-sectional view depicting a display operating in only the reflective mode of operation. If the illumination control module 124 receives a measurement signal above the first minimum threshold, it supplies no LED enable signal to LED 114-0, corresponding to waveguide pipe 108-0 underlying selected display pixel 104-1 in sequence 1. Selected display pixel 104-1 returns incident light received from the ambient environment, but transmits no light extracted from the underlying waveguide pipe 108-0.

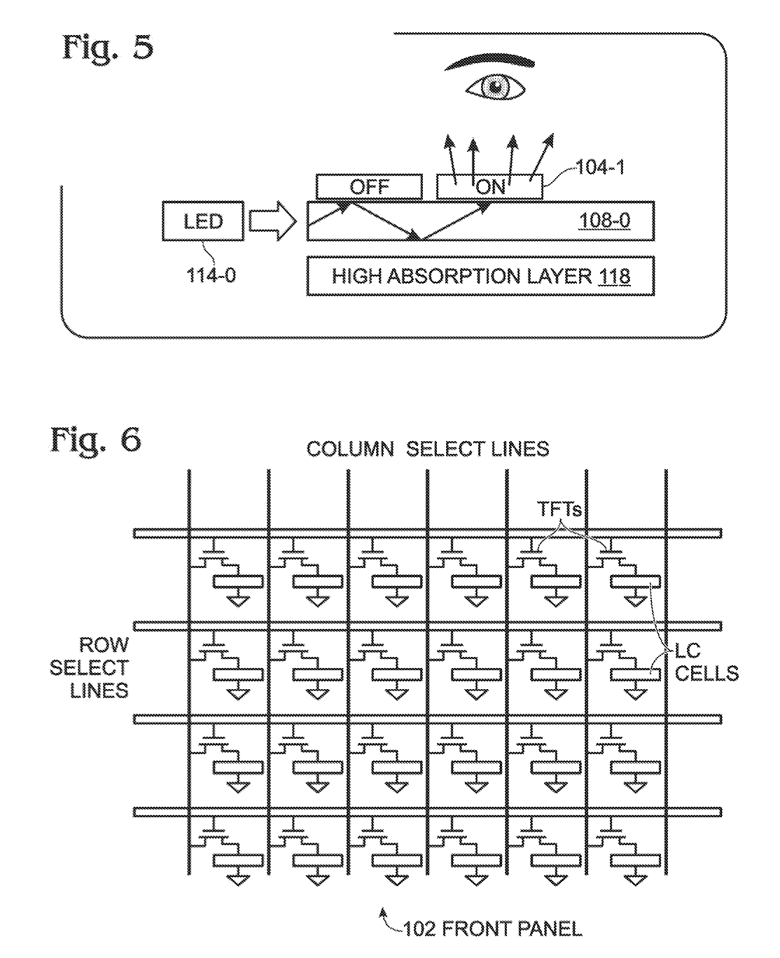

FIG. 5 is a partial cross-sectional view depicting a display operating in primarily the transmissive mode of operation. If the illumination control module 124 receives a measurement signal on line 122 below the second minimum threshold, it supplies an LED enable signal to LED 114-0 corresponding to waveguide pipe 108-0 underlying the selected display pixel 104-1. Selected display pixel 104-1 primarily transmits light extracted from the underlying waveguide.

In one aspect, the medium 200 (see FIG. 2) in the selected display pixel 104-1 can be operated with a medium scattering strength, less than the high scattering strength, in responsive to an MID voltage between the electrodes 202. The MID voltage is a voltage less than the ON voltage, but greater than the OFF voltage. The selected display pixel 104-1 returns incident light with a third reflection efficiency, less than the first reflection efficiency, but greater than the second reflection efficiency.

Likewise, if the medium in the selected display pixel operates with a medium scattering strength in responsive to the MID voltage, light is extracted from the waveguide pipe 108 with a third extraction efficiency, less than the first extraction efficiency, but greater than the second extraction efficiency.

### Functional Description

FIG. 6 is a schematic diagram depicting an exemplary front panel. The display pixels of the front panel described in FIGS. 1A and 1B may be enabled using an active matrix liquid crystal displays (AMLCDs). The active matrix is a method of addressing an array of simple LC cells—one cell per monochrome pixel. In its simplest form there is one thin-film transistor for each cell. A row of pixels is selected by applying the appropriate select voltage to the select line connecting the TFT gates for that row of pixels. When a row of pixels is selected, a desired voltage to each pixel is supplied via its data (column select) line. When a pixel is selected, it is uniquely given an ON voltage that is not supplied to any non-selected pixels. The non-selected pixels should be completely isolated from the voltages circulating through the array for the selected pixels. Ideally, the TFT active matrix can be considered as an array of switches. All rows are selected in one scanning period. Thus, if there are 500 lines and the time to load data into each selected line is 50 microseconds, then a single scanning period is 25 microseconds, for a field-scanning rate of 40 Hz.

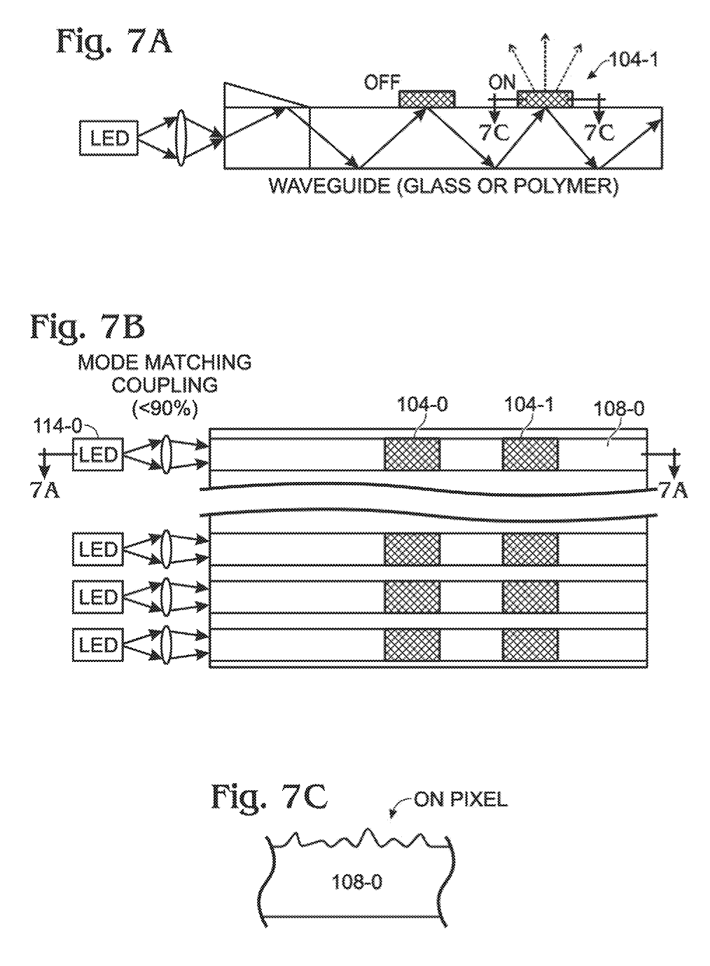

FIGS. 7A, 7B, and 7C are, respectively, a partial cross-sectional view, detailed partial cross-sectional view, and plan view illustrating the concept of addressing individual backlight display pixels for an edge-coupled LED backlight system. Local dimming functions are associated with a controlled surface roughness. That is, roughing can be used to disable the total internal reflections required for light waveguiding, so that light is emitted from the waveguide in selected desired sites. As explained in more detail below, roughing is a construct useful in explaining the concept of scattering.

Numerical models have been developed that show that the scattered light from waveguide light pipes is strongly angular dependent due to a scattering mechanism based on the relative ratio between the dimension scale of the scatters and light wavelengths. Most of the scattering events can be regarded as Mie scattering. Mie theory, also called Lorenz-Mie theory or Lorenz-Mie-Debye theory, is an analytical solution of Maxwell's equations for the scattering of electromagnetic radiation by spherical particles (also called Mie scattering). This approach is used to explain the behavior of light in interactions with particles having a size similar to that of the wavelength of light.

Since Mie scattering is the dominate scattering mechanism inside the addressable scattering LC cells, it is convenient to define a scattering mean free path, Lₘₑₐₙ, which is inversely proportional to the product of average scattering cross-section of scatters, σs_{c}, and scatter density, N, where N is defined as the average particle numbers inside a unit volume.

Lₘₑₐₙ˜1/(σs_{c}×N) Equation 1

As shown in FIG. 7C, the desired light extraction from waveguide light pipe can be created from non-uniform optical index profiles. The scattering by the non-uniform surfaces disables the total internal reflections, which leads to the leakage of light into air.

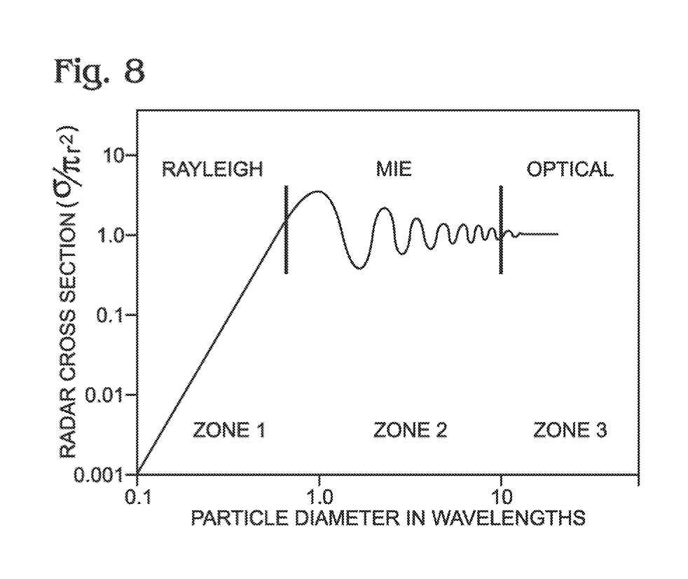

FIG. 8 is a graph depicting a scattering function (radar cross section) as a function of particle size. Based on the dimensions of the scatters, the surface roughness can be roughly divided into three zones, with zone 2 being of special interest. The overall scattering strengths can be characterized by the mean free path, L, as described above in Equation 1. It is found that smaller mean free path leads to high extraction efficiencies.

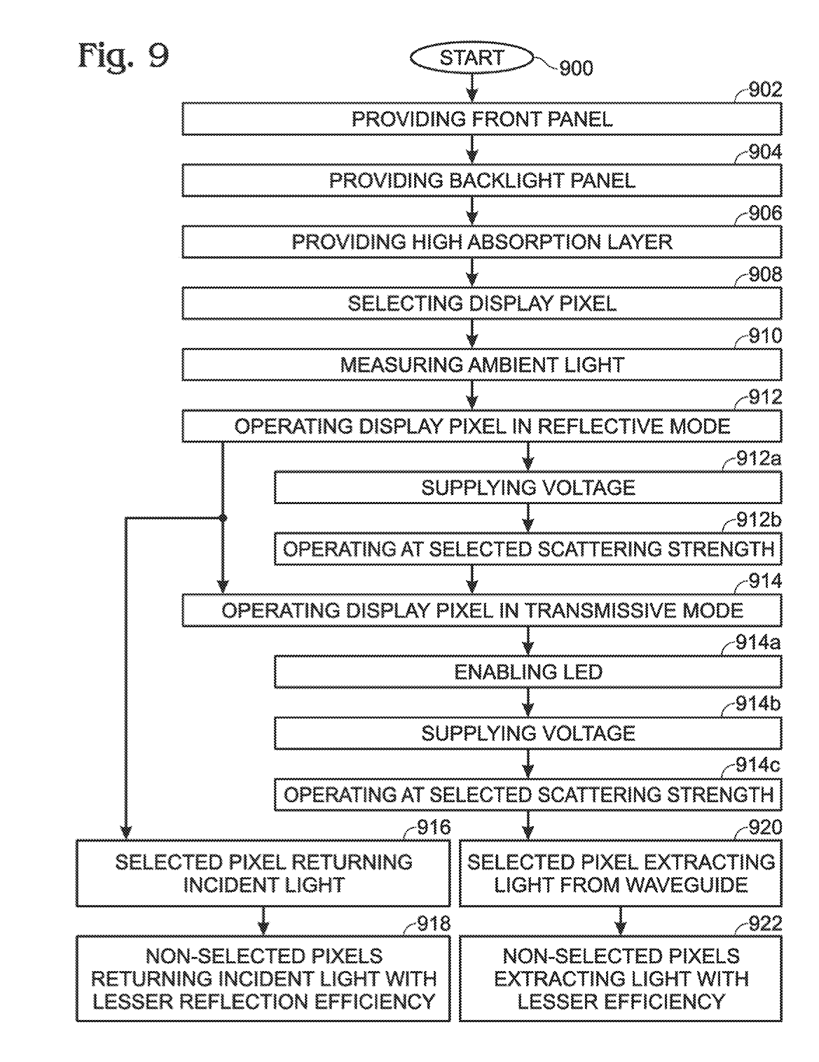

FIG. 9 is a flowchart illustrating a scattering tunable display method using reflection and edge-lit waveguide transmission modes of illumination. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the steps are performed in numerical order. The method starts at Step 900.

Step 902 provides a front panel with an array of selectable display pixels arranged in a plurality of sequences. Step 904 provides a backlight panel with a plurality of edgecoupled waveguide pipes formed in a plurality of rows. Each waveguide pipe has an optical input connected to a corresponding light emitting diode (LED), and an optical output index-matched to a corresponding sequence of display pixels. Step 906 provides a high absorption layer underlying the backlight panel. Step 908 selects a display pixel to enable. Step 910 measures ambient visible spectrum illumination incident to a top surface of the front panel. In response to the measured ambient illumination being above a first minimum threshold, Step 912 operates the display pixel in a reflective illumination mode. In response to the measured ambient illumination being below the first minimum threshold, Step 914 operates the display pixel in a transmissive illumination mode.

In one aspect, Step 902 provides selectable display pixels with a medium of liquid crystal molecules, embedded in a polymer network, and interposed between transparent electrodes. Then, operating the display pixel in Step 912 and 914 includes creating a biased potential between the electrodes of the selected display pixel.

In another aspect, operating the display pixels in the reflective illumination mode (Step 912) includes substeps. Step 912a supplies an ON voltage to the selected display pixel. In Step 912b, the medium in the selected display pixel operates at a high scattering strength in response to the ON voltage. In Step 916 the selected display pixel returns incident light with a first reflection efficiency. In Step 918 non-selected display pixels return incident light with a second reflection efficiency, less than the first reflection efficiency.

In one variation, Step 912a supplies a MID voltage to the selected display pixel, and in Step 912b the medium in the selected display pixel operates at a medium scattering strength, less than the high scattering strength, in response to the MID voltage. Then, in Step 916 the selected pixel returns incident light with a third reflection efficiency, less than the first reflection efficiency, but greater than the second reflection efficiency.

Operating the display pixels in a transmissive illumination mode may include the following substeps. Step 914a enables a first LED corresponding to a waveguide pipe underlying the selected display pixel. Step 914b supplies an ON voltage to the selected display pixel. In Step 914c the medium in the selected display pixel operates at a high scattering strength in response to the ON voltage. In Step 920 the selected display pixel extracts light received from the waveguide pipe with a first extraction efficiency. In Step 922 non-selected display pixels in the same sequence as the selected display pixel extract light from the waveguide pipe with a second extraction efficiency, less than the first extraction efficiency.

In one variation, Step 914b supplies a MID voltage to the selected display pixel, and in Step 914c the medium in the selected display pixel operates at a medium scattering strength, less than the high scattering strength, in response to the MID voltage. Then, in Step 920 the selected display pixel extracts light received from the waveguide pipe with a third extraction efficiency, less than the first extraction efficiency, but greater than the second extraction efficiency.

In one aspect, Step 910 measures ambient illumination below the first minimum threshold, but above a second minimum threshold. Then, Steps 912 and 914 operate the display pixel in a combination of both reflective and transmissive illumination modes. If Step 910 measures ambient illumination above the first minimum threshold, Step 912 operates the selected display pixel exclusively in the reflective mode. If Step 910 measures ambient illumination below the second minimum threshold, Step 914 operates the display pixel primarily in the transmissive illumination mode.

A display has been provided that uses both reflective and transmissive modes of illumination. Examples of particular materials and dimensions have been given to illustrate the invention, but the invention is not limited to just these examples. Other variations and embodiments of the invention will occur to those skilled in the art.

We claim:

1. A scattering tunable display method using reflection and edge-lit waveguide transmission modes of illumination, the method comprising:
providing a front panel with an array of selectable display pixels arranged in a plurality of sequences;
providing a backlight panel with a plurality of edge-coupled waveguide pipes formed in a plurality of rows, where each waveguide pipe has an optical input connected to a corresponding light emitting diode (LED), and an optical output index-matched to a corresponding sequence of display pixels;
providing a high absorption layer underlying the backlight panel;
selecting a display pixel to enable;
measuring ambient visible spectrum illumination incident to a top surface of the front panel;
in response to the measured ambient illumination being above a first minimum threshold, operating the display pixel in a reflective illumination mode; and,
in response to the measured ambient illumination being below the first minimum threshold, operating the display pixel in a transmissive illumination mode.

2. The method of claim 1 wherein providing the front panel includes providing selectable display pixels with a medium of liquid crystal molecules, embedded in a polymer network, and interposed between transparent electrodes; and,
wherein operating the display pixel includes creating a biased potential between the electrodes of the selected display pixel.

3. The method of claim 1 wherein operating the display pixels in the reflective illumination mode includes:
supplying an ON voltage to the selected display pixel;
in response to the ON voltage, the medium in the selected display pixel operating at a high scattering strength;
the method further comprising:
the selected display pixel returning incident light with a first reflection efficiency; and,
non-selected display pixels returning incident light with a second reflection efficiency, less than the first reflection efficiency.

4. The method of claim 1 wherein operating the display pixels in a transmissive illumination mode includes:
enabling a first LED corresponding to a waveguide pipe underlying the selected display pixel;
supplying an ON voltage to the selected display pixel;
in response to the ON voltage, the medium in the selected display pixel operating at a high scattering strength;
the method further comprising:
the selected display pixel extracting light received from the waveguide pipe with a first extraction efficiency; and,
non-selected display pixels in the same sequence as the selected display pixel extracting light from the waveguide pipe with a second extraction efficiency, less than the first extraction efficiency.

5. The method of claim 1 wherein measuring the ambient illumination includes measuring ambient illumination below the first minimum threshold, but above a second minimum threshold; and,
wherein operating the display pixel includes operating the display pixel in a combination of both reflective and transmissive illumination modes.

6. The method of claim 1 wherein operating the selected display pixel in response to the measured ambient illumination being above the first minimum threshold includes operating the selected display pixel exclusively in the reflective mode.

7. The method of claim 5 wherein measuring the ambient illumination includes measuring ambient illumination below the second minimum threshold; and,
wherein operating the display pixel includes operating the display pixel primarily in the transmissive illumination mode.

8. The method of claim 3 wherein operating the display pixels in the reflective illumination mode includes:
supplying a MID voltage to the selected display pixel;
in response to the MID voltage, the medium in the selected display pixel operating at a medium scattering strength, less than the high scattering strength;
wherein the selected display pixel returning incident light includes the selected pixel returning incident light with a third reflection efficiency, less than the first reflection efficiency, but greater than the second reflection efficiency.

9. The method of claim 4 wherein operating the display pixels in a transmissive illumination mode includes:
supplying a MID voltage to the selected display pixel;
in response to the MID voltage, the medium in the selected display pixel operating at a medium scattering strength, less than the high scattering strength; and,
wherein the selected display pixel extracting light includes the selected display pixel extracting light received from the waveguide pipe with a third extraction efficiency, less than the first extraction efficiency, but greater than the second extraction efficiency.

10. A scattering tunable display using reflection and edge-lit waveguide transmission modes of illumination, the display comprising:
a front panel with an array of selectable display pixels arranged in a plurality of sequences;
a backlight panel with a plurality of edge-coupled waveguide pipes formed in a plurality of rows, where each waveguide pipe has an optical input connected to an edge and an optical output surface underlying a corresponding display pixel sequence;
a plurality of light emitting diodes (LEDs), each LED having an optical output connected to a corresponding waveguide pipe edge;
an index-matching layer interposed between the backlight panel and the front panel;
a high absorption layer underlying the backlight panel;
a light gauge mounted to the front panel having an electrical output to supply a measurement signal response to the intensity of ambient visible spectrum light incident to the front panel;
an illumination control module having an input to accept the measurement signal and an output to supply an LED enable signal responsive to the measurement signal; and,
wherein the illumination control module, in response to an ambient illumination measurement being above a first minimum threshold, operates selected display pixels in a reflective illumination mode, and in response to the ambient illumination measurement being below the first minimum threshold, operates the selected display pixels in a transmissive illumination mode.

11. The display of claim 10 wherein each display pixel includes a medium of liquid crystal molecules, embedded in a polymer network, and interposed between transparent electrodes.

12. The display of claim 11 wherein the medium in a selected display pixel operates with a high scattering strength in response to an ON voltage between the electrodes, returning incident light with a first reflection efficiency; and,
wherein the medium in non-selected display pixels operates with a low scattering strength in responsive to an OFF voltage between the electrodes, returning incident light with a second reflection efficiency, less than the first reflection efficiency.

13. The display of claim 10 wherein the illumination control module enables a first LED corresponding to a waveguide pipe underlying a selected display pixel;
wherein the medium in the selected display pixel operates with a high scattering strength in responsive to an ON voltage between the electrodes, extracting light from the waveguide pipe with a first extraction efficiency; and,
wherein the medium in non-selected display pixels operates with a low scattering strength in responsive to an OFF voltage between the electrodes, extracting light from the waveguide pipe with a second extraction efficiency, less than the first extraction efficiency.

14. The display of claim 10 wherein the illumination control module receives a measurement signal below the first minimum threshold, but above a second minimum threshold, and supplies an LED enable signal to a first LED corresponding to a waveguide pipe underlying a selected display pixel; and,
wherein the selected display pixel returns ambient incident light and transmits light extracted from the underlying waveguide pipe.

15. The display of claim 10 wherein the illumination control module receives a measurement signal above the first minimum threshold, but above a second minimum threshold, and supplies no LED enable signal to a first LED corresponding to a waveguide pipe underlying a selected display pixel; and,
wherein the selected display pixel returns incident light received from the ambient environment, and transmits no light extracted from the underlying waveguide pipe.

16. The display of claim 14 wherein the illumination control module receives a measurement signal below the second minimum threshold, and supplies an LED enable signal to the first LED corresponding to the waveguide pipe underlying the selected display pixel; and,
wherein the selected display pixel primarily transmits light extracted from the underlying waveguide pipe.

17. The display of claim 12 wherein the medium in the selected display pixel operates with a medium scattering strength, less than the high scattering strength, in responsive to an MID volt'age between the electrodes, returning incident light with a third reflection efficiency, less than the first reflection efficiency, but greater than the second reflection efficiency.

18. The display of claim 13 wherein the medium in the selected display pixel operates with a medium scattering strength, less than the high scattering strength, in responsive to an MID voltage between the electrodes, extracting light from the waveguide pipe with a third extraction efficiency, less than the first extraction efficiency, but greater than the second extraction efficiency.

19. A scattering tunable display using reflection and edge-lit waveguide transmission modes of illumination, the display comprising:
a front panel with an array of selectable display pixels arranged in a plurality of sequences;
a backlight panel with a single edge-coupled waveguide pipe having an optical input connected to an edge and an optical output surface underlying the plurality of display pixel sequences;
a plurality of light emitting diodes (LEDs), each LED having an optical output connected to the waveguide pipe edge;
an index-matching layer interposed between the backlight panel and the front panel;
a high absorption layer underlying the backlight panel;
a light gauge mounted to the front panel having an electrical output to supply a measurement signal response to the intensity of ambient visible spectrum light incident to the front panel;
an illumination control module having an input to accept the measurement signal and an output to supply an LED enable signal responsive to the measurement signal; and,
wherein the illumination control module, in response to an ambient illumination measurement being above a first minimum threshold, operates selected display pixels in a reflective illumination mode, and in response to the ambient illumination measurement being below the first minimum threshold, operates the selected display pixels in a transmissive illumination mode.
